(19) United States
(12) Patent Application Publication
(10) Pub. No.: US 2004/0029669 A1
(43) Pub. Date: Feb. 12, 2004

(54) Reinforcing cable for a flexible endless caterpillar track

(75) Inventor: Olivier Phely, Thenisy (FR)

Correspondence Address: DENNISON, SCHULTZ & DOUGHERTY, 1745 JEFFERSON DAVIS HIGHWAY, ARLINGTON, VA, 22202, US

(73) Assignee: OTICO

(21) Appl. No.: 10/615,912

(22) Filed: Jul. 10, 2003

(30) Foreign Application Priority Data
Aug. 7, 2002 (FR) 0210054

(51) Int. Cl. F16G 1/28; F16H 55/30

(52) U.S. Cl. 474/202; 474/260; 474/152

(57) ABSTRACT

The invention relates to a reinforcing cable for a flexible endless caterpillar track made of an elastomer. The cable (30) comprises a plurality of strands (32C, 32P) each formed from steel filaments and arranged so as to be wound in a helix in the thickness of the belt. Each strand comprises a core composed of at least three filaments (34), an intermediate layer composed of a plurality of filaments (36) and surrounding the core, and an outer layer composed of a plurality of filaments (38) surrounding the intermediate layer. Application to caterpillar tracks for all-terrain vehicles.

### BACKGROUND OF THE INVENTION

1. Field of the Invention

The invention relates to a reinforcing cable for a flexible endless caterpillar track and to the caterpillar tracks equipped with such a cable.

More particularly, the invention relates to a reinforcing cable for a caterpillar track with a flexible endless belt made of an elastomer, this cable comprising a plurality of strands, also called cable strands, each formed from steel filaments, the cable being designed to be wound in a helix in the thickness of the belt, thus forming several turns that are generally parallel to one another.

2. Description of the Related Art

Flexible belt caterpillar tracks are used increasingly to replace conventional caterpillar tracks composed of mutually articulated metal links.

Such flexible caterpillar tracks are applicable in many all-terrain vehicles, such as agricultural and civil engineering machines.

A flexible caterpillar track of this type is composed of a flexible endless belt made of an elastomer, generally based on natural rubber, which is wound around two end wheels, at least one of which is driven.

Such a flexible belt is generally provided, on its outer side, with spikes in order to promote adhesion with the ground and, on its inner side, with means for meshing with the drive wheel(s).

A caterpillar track with a flexible endless belt of this type is known for example from Patent FR-A-2 711 959 (9313211) in the name of the Applicant. This endless belt has, on the outside, a spiked rolling surface and it is provided on the inside with a row of pyramid-shaped projections, located in the length direction of the belt and generally equidistant apart.

This flexible belt is reinforced internally, that is to say in its thickness, by reinforcements obtained, in a conventional manner, by the superposition of plies of warp and weft materials.

As already indicated, the belt is essentially reinforced by a steel cable that is wound in a helix in the thickness of the belt, forming turns that are generally parallel to one another.

On the outside of the cable are usually provided layers of stiffening elements that are located on the inner and/or outer side of the belt with respect to the turns of the cable.

The design of a reinforcing cable poses many difficulties in practice.

Firstly, this cable must have a high tensile strength in order to allow the belt to withstand the particularly large forces that it is subjected to when mounted on an all-terrain vehicle.

These forces include in particular a belt pretensioning force and torque transfer forces at the drive wheel.

Apart from this high tensile strength condition, the cable must exhibit great longitudinal flexibility in order to allow deformation of the belt during its operation and thus limit the power absorbed when winding the belt. In addition, such a cable must be small in size, given the relatively small thickness of the belt; typically, this is generally between 26 and 30 millimetres.

The cable must therefore have a favourable size/tensile strength ratio. Moreover, it is essential for the cable, which is embedded in the thickness of the belt, to be able to adhere perfectly to the material of the belt and for this material to be able to penetrate into the very structure of the cable.

Various solutions have been proposed hitherto for trying to remedy the abovementioned problem.

In most of the known solutions, each cable strand comprises two layers, namely an inner layer, also called a core, which may be limited to a single filament, and an outer layer composed of several filaments which may or may not be identical to the filaments of the core and which form twisted assemblies around the inner filament.

These known solutions do not allow the various abovementioned criteria to be met.

### SUMMARY OF THE INVENTION

The object of the invention is to overcome the aforementioned drawbacks.

The aim of the invention is in particular to provide a reinforcing cable for a caterpillar track with a flexible endless belt made of an elastomer, of the type defined above, that combines the advantages of small size with a high tensile strength and that has a structure facilitating the penetration of the elastomer material when the cable is embedded in a belt made of an elastomer.

The invention also aims to provide a reinforcing cable of this type that is applicable in various types of caterpillar tracks capable of being produced in various sizes and suitable for various types of all-terrain vehicles.

The aim of the invention is also to provide a caterpillar track with a flexible endless belt equipped with such a reinforcing cable.

For this purpose, the invention provides a reinforcing cable of the type defined above, in which each strand comprises a core composed of at least three filaments, an intermediate layer composed of a plurality of filaments and surrounding the core, and an outer layer composed of a plurality of filaments and surrounding the intermediate layer.

Thus, the cable of the invention is composed of three layers, namely the core forming the inner layer, the intermediate layer and the outer layer. Such a three-layer structure is likely to favour, for the same size as cables of the prior art, greater longitudinal flexibility while maintaining the advantages of a high tensile strength.

The cable of the invention also offers the advantage of having a better fatigue strength because of the large number of strands of which it is composed.

Moreover, this particular three-layer structure facilitates penetration of the elastomer material when the cable is embedded in the endless belt during its manufacture.

In one preferred embodiment of the invention, the core is composed of three twisted filaments, the intermediate layer is composed of nine twisted filaments and the outer layer is composed of fifteen twisted filaments. In such a cable, it is advantageous for the filaments of the core, the filaments of the intermediate layer and the filaments of the outer layer all to have the same diameter.

In this preferred embodiment of the invention, the cable comprises a central strand surrounded by six peripheral strands.

Thus, in this preferred embodiment, the cable comprises a central strand surrounded by six peripheral strands and the strands are all identical and each comprise a core composed of three twisted filaments, an intermediate layer composed of nine twisted filaments and an outer layer composed of fifteen twisted filaments.

In the invention, the filaments have a diameter of between 0.2 and 0.3 mm and preferably close to 0.25 mm.

As regards the cable, its diameter is advantageously between 4 and 6 mm, and preferably close to 5 mm.

According to another aspect, the invention relates to a caterpillar track with a flexible endless belt made of an elastomer, which includes a reinforcing cable as defined above, this cable being wound in a helix in the thickness of the belt in order to form a plurality of turns that are generally parallel to one another.

This caterpillar track advantageously comprises at least two layers of stiffening elements embedded in the thickness of the belt and each lying in a direction transverse or oblique to the turns of the cable.

In particular, the caterpillar track may comprise a layer called the “inner layer” located on the inner side of the belt with respect to the turns of the cable and composed of stiffening elements lying in a direction transverse to the turns of the cable.

The caterpillar track may also comprise at least two layers called “outer layers” located on the outer side of the belt with respect to the turns of the cable and composed of stiffening elements lying in a direction transverse or oblique to the turns of the cable.

Thus, in one embodiment, the caterpillar track comprises two outer layers composed respectively of stiffening elements lying in different oblique directions to the turns of the cable in order to form crossed plies.

If appropriate, the caterpillar track may furthermore include an additional outer layer composed of stiffening elements lying in a direction transverse to the turns of the cable.

In such a caterpillar track, the stiffening elements preferably have different dimensions in the width direction of the belt, this being so as to prevent the formation of hard spots that would run the risk of causing the elastomer material to debond.

### BRIEF DESCRIPTION OF DRAWINGS

The above and other objects, features and advantages of the invention will become more apparent from the following description of the preferred embodiments taken in connection with the accompanying drawings in which:

FIG. 1 is a partial side view of a flexible caterpillar track wound around a drive wheel;

FIG. 2 is a sectional view of a strand composed of three layers of filaments suitable for forming part of a reinforcing cable according to the invention;

FIG. 3 is a sectional view of a reinforcing cable comprising seven strands as shown in FIG. 2;

FIGS. 4 to 8 are sectional views of five flexible endless belts provided with a reinforcing cable according to the invention and with various types of stiffening element;

FIG. 9 is a schematic top view showing two crossed plies of stiffeners; and

FIG. 10 is a top view showing a ply of stiffening elements lying in a direction transverse to the turns of the reinforcing cable.

### DETAILED DESCRIPTION OF THE PREFERRED EMBODIMENTS

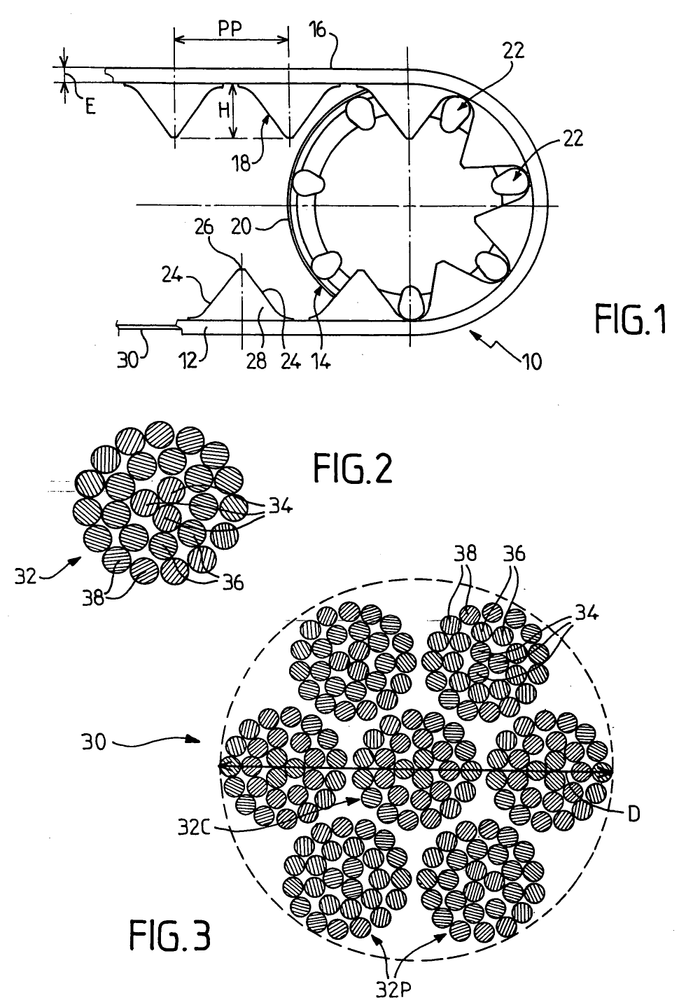

Referring firstly to FIG. 1, this shows a drive device of a flexible caterpillar track 10 wound around a drive wheel 14. Such a drive device can be fitted to all-terrain vehicles of various types, for example agricultural machines, civil engineering machines, etc. The caterpillar track 10 is formed from a flexible endless belt 12 made of an elastomer material, for example one based on natural rubber and reinforced internally, that is to say in its thickness, by reinforcements, as will be seen later.

These reinforcements are formed by the superposition of plies of warp and weft material, generally comprising metal yarns.

The endless belt 12 has, on the outside, a rolling surface 16 usually provided with spikes (not shown in FIG. 1). It is provided on the inside with a row of projections 18 located in the length direction of the belt and in principle equidistant apart with a pitch PP.

The drive wheel 14 is formed from two symmetrical wheel rims 20 joined together, at regular intervals, by drive dogs 22. These dogs are placed so as to be parallel to one another around the periphery of the wheel and parallel to the generatrices of the latter. They are separated from one another, around the periphery of the drive wheel 14, with a circumferential pitch whose value is between 93% and 100% of the value PP of the pitch of the projections 18, which have a height H.

As may also be seen in FIG. 1, the projections 18 have approximately the shape of a pyramid. They each comprise two oblique faces 24 terminating in an upper face 26 and two side faces 28.

The flexible endless belt 12, excluding the spikes (not shown) and the projections, have a thickness E of typically between 26 and 30 mm, usually close to 28 mm.

The belt 12 is reinforced internally, that is to say in its thickness, by a reinforcing cable 30 which is wound continuously in a helix so as to form turns that are generally parallel to one another.

Referring now to FIG. 2, this shows a strand 32 suitable for forming part of a reinforcing cable, in a preferred embodiment of the invention.

The strand 32 of FIG. 2 is composed of three superposed layers, an inner layer called the core composed of three twisted filaments 34, an intermediate layer composed of nine twisted filaments 36 and an outer layer composed of fifteen twisted filaments 38. In the example, all the filaments are identical and are made of steel. Typically, they have a diameter of between 0.2 and 0.3 mm, preferably close to 0.25 mm. The twisted assemblies made up of the filaments 34 of the core, the filaments 36 of the intermediate layer and the filaments 38 of the outer layer preferably have different pitches. It may be seen that an aerated structure is thus formed, since it leaves gaps between the layers. Despite this aerated structure, the strand has the advantage of offering great flexibility and a high tensile strength. It may also be seen that there is a void at its centre, that is to say along the neutral fibre, this having advantages as regards the strength of the cable. This also allows the elastomer material to penetrate somewhat into the very core of the strand.

Referring now to FIG. 3, this shows a cable 30 obtained by assembling seven strands 32 as shown in FIG. 2. These seven strands are identical to one another. They comprise a central strand 32C surrounded by six peripheral strands 32P. In such a cable, the peripheral strands 32P are twisted with respect to the central strand 32C.

When the cable 30 of FIG. 3 is composed of filaments typically having a diameter of between 0.2 and 0.3 mm, the diameter of the cable is generally between 4 and 6 mm. This diameter value is favourable and particularly suitable for a belt whose thickness E is between 26 and 30 mm, as already indicated.

In one embodiment of a cable according to FIG. 3, all the filaments of the seven strands have a diameter of 0.245 mm. In other words, the structure of the cable may thus be given as: 7×(3×0.245 mm+9×0.245 mm+15×0.245 mm).

As a variant, the cable could comprise, for example, seven strands each with four core filaments 34 of 0.22 mm diameter, nine filaments 36 of 0.245 mm diameter of the intermediate layer and fifteen filaments 38 of 0.245 mm diameter of the outer layer. The structure of such a cable is thus given as 7×(4×0.22 mm+9×0.245 mm+15×0.245 mm).

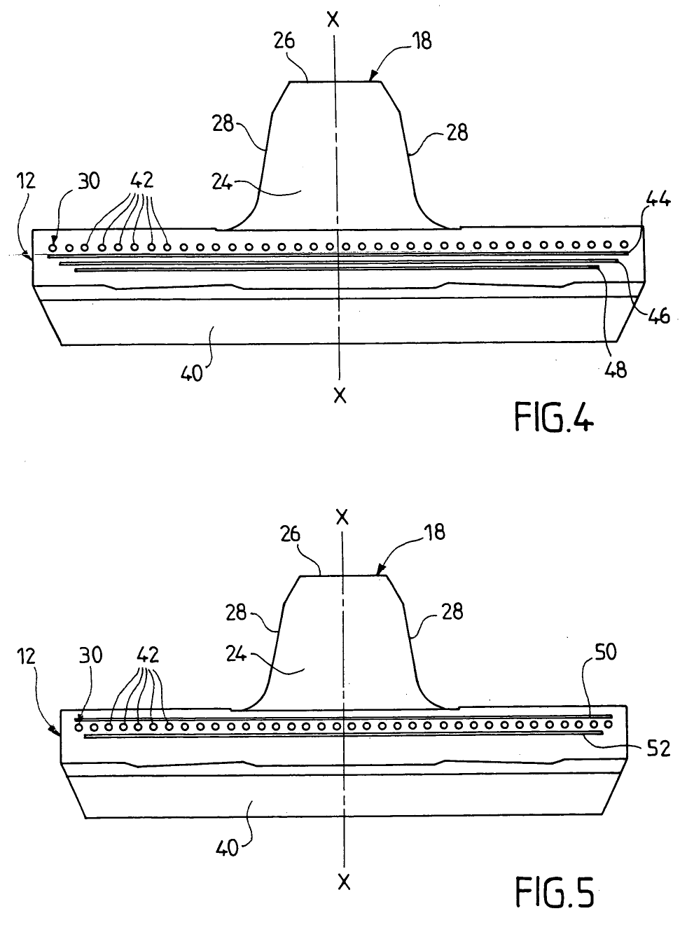

Referring now to FIG. 4, this shows in cross section a belt in a first embodiment of the invention. The belt 12 is provided on the inside with projections 18 and on the outside with spikes 40. Embedded in the thickness of the belt is a cable 30 according to the invention, which is wound in a helix in order to form a plurality of turns 42 lying parallel to one another. The belt is also reinforced by three layers of stiffening elements that all lie on the outer side of the belt with respect to the turns 42 of the cable. In other words, these three layers are all located on that side of the belt 12 with the spikes 40.

In this figure may be distinguished an outer first layer 44, formed from stiffeners lying in an oblique direction, a second layer 46 of stiffeners lying in another oblique direction and a third layer 48 of stiffeners lying in a transverse direction. The stiffeners of the layers 44 and 46 are mutually crossed as may be seen in FIG. 9.

As may be more clearly seen in FIG. 9, the stiffeners 44 make an angle α to a perpendicular to the turns 42, while the stiffeners of the layer 46 also make an angle α to this same perpendicular, but in the opposite direction. The angle α may, for example, be 20 degrees.

In contrast, as may be seen in FIG. 10, the stiffeners of the layer 48 lie in a transverse direction, that is to say perpendicular to the turns 42.

As may be seen in the cross section shown in FIG. 4, the layers 44, 46 and 48 extend over different widths in the width direction of the belt. This means that they terminate at different distances from the mid-axis of the belt. This prevents the formation of hard spots liable to favour debonding of the elastomer material in which the cable and the layers of stiffeners are embedded.

Advantageously, the stiffeners are formed from metal wires or synthetic yarns embedded in a layer of an elastomer, for example a rubber, forming a calendered ply.

In the embodiment shown in FIG. 5, the belt comprises an inner layer 50 formed from stiffening elements that lie in the transverse direction and an outer layer 52 formed from stiffening elements that also lie in the transverse direction.

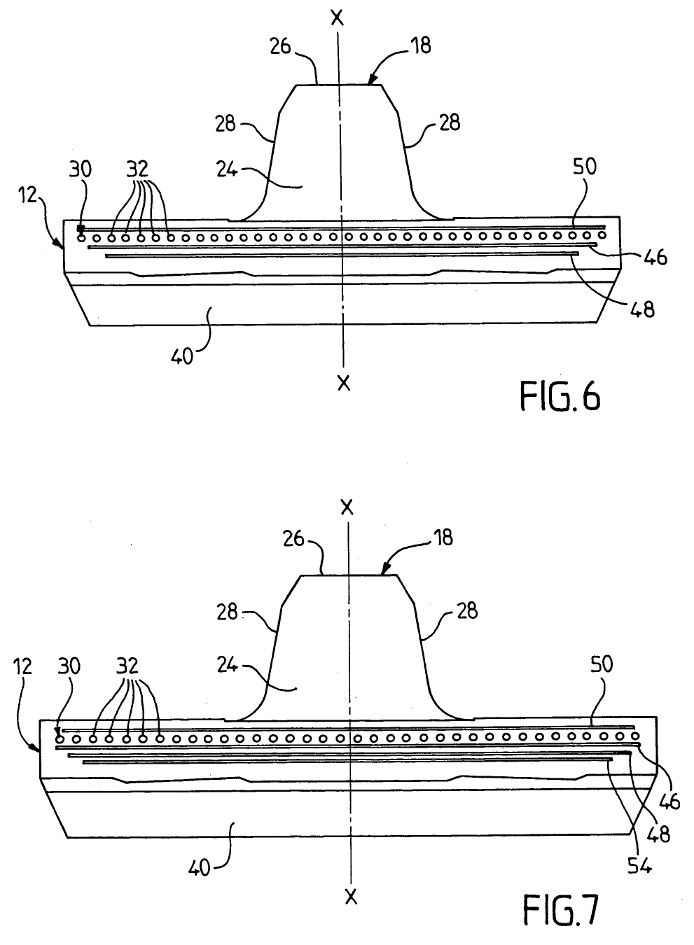

In the embodiment shown in FIG. 6, the belt comprises an inner layer 50 of stiffening elements similar to the layer 50 shown in FIG. 4. It also includes two outer layers, namely two oblique layers 46 and 48 similar to those of FIG. 4. The two oblique layers form crossed layers.

In the embodiment shown in FIG. 7, which is similar to that shown in FIG. 6, there is again an inner layer 50 and two outer layers 46 and 48. An additional layer 54 formed from stiffening elements lying in the transverse direction is also provided in the thickness of the belt.

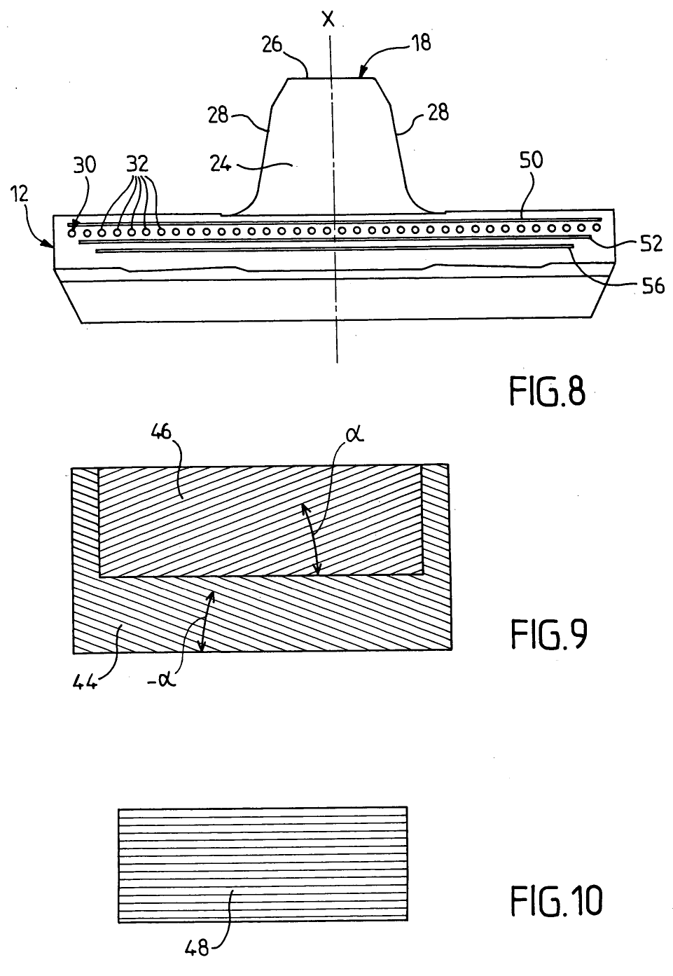

Finally, in the embodiment shown in FIG. 8, there are also two outer layers, namely a layer 52 similar to that shown in FIG. 5 and composed of stiffening elements lying in the transverse direction and another outer layer 56 composed of stiffening elements also lying in the transverse direction.

The stiffening elements shown in FIGS. 4 to 8 typically have a thickness or a diameter of less than that of the cable 30.

Of course, other types of stiffening element are possible within the scope of the invention.

The cable of the invention is itself capable of many alternative embodiments.

Thus, the core of the strand could be formed from four filaments instead of three, and these filaments could have a smaller diameter than the filaments of the intermediate layer and of the outer layer.

However, in the preferred embodiment of the invention, all the filaments have the same diameter in order to facilitate manufacture.

As already indicated, the cable of the invention offers the advantage of combining high longitudinal flexibility, a high tensile strength, a small size and accessibility to the elastomer material in which the cable is embedded.

It also exhibits better fatigue strength when being wound and bent.

The caterpillar track of the invention can be used in various types of all-terrain vehicle.

What is claimed is:

1. A reinforcing cable for a caterpillar track, the caterpillar track having a flexible endless belt made of an elastomer, the reinforcing cable comprising a plurality of strands each formed from steel filaments and arranged so as to be wound in a helix in the thickness of the belt, wherein each strand comprises a core composed of at least three filaments, an intermediate layer composed of a plurality of filaments and surrounding the core, and an outer layer composed of a plurality of filaments and surrounding the intermediate layer.

2. A reinforcing cable according to claim 1, wherein the core is composed of three twisted filaments, the intermediate layer is composed of nine twisted filaments and the outer layer is composed of fifteen twisted filaments.

3. A reinforcing cable according to claim 2, wherein the filaments of the core, the filaments of the intermediate layer and the filaments of the outer layer all have the same diameter.

4. A reinforcing cable according to claim 1, which comprises a central strand surrounded by six peripheral strands.

5. A reinforcing cable according to claim 4, which comprises a central strand surrounded by six peripheral strands and in that the strands are all identical and each comprise a core composed of three twisted filaments, an intermediate layer composed of nine twisted filaments and an outer layer composed of fifteen twisted filaments.

6. A reinforcing cable according to claim 1, wherein the filaments have a diameter of between 0.2 and 0.3 mm and preferably close to 0.25 mm.

7. A reinforcing cable according to claim 1, wherein the cable has a diameter of between 4 and 6 mm and preferably close to 5 mm.

8. A caterpillar track comprising a flexible endless belt made of an elastomer and a reinforcing cable which comprises a plurality of strands each formed from steel filaments and arranged so as to be wound in a helix in the thickness of the belt, wherein each strand comprises a core composed of at least three filaments, an intermediate layer composed of a plurality of filaments (36) and surrounding the core, and an outer layer composed of a plurality of filaments and surrounding the intermediate layer, wherein the reinforcing cable is wound in a helix in the thickness of the belt in order to form a plurality of turns that are generally parallel to one another.

9. A caterpillar track according to claim 8, comprising at least two layers of stiffening elements embedded in the thickness of the belt and each lying in a direction transverse or oblique to the turns of the cable.

10. A caterpillar track according to claim 9, comprising a layer located on the inner side of the belt with respect to the turns of the cable and composed of stiffening elements lying in a direction transverse to the turns of the cable.

11. A caterpillar track according to claim 9, comprising at least two layers located on the outer side of the belt with respect to the turns of the cable and composed of stiffening elements lying in a direction transverse or oblique to the turns of the cable.

12. A caterpillar track according to claim 11, comprising two outer layers composed respectively of stiffening elements lying in different oblique directions to the turns of the cable in order to form crossed plies.

13. A caterpillar track according to claim 12, comprising an additional outer layer composed of stiffening elements lying in a direction transverse to the turns of the cable.

14. A caterpillar track according to claim 9, wherein the layers of stiffening elements have different dimensions in the width direction of the belt.
